(19) United States
(12) Patent Application Publication
(10) Pub. No.: US 2024/0122343 A1
(43) Pub. Date: Apr. 18, 2024

(54) MAGNETIC DINNERWARE STORAGE SYSTEM

(71) Applicant: BELLA TERRA INTERIOR SOLUTIONS, LLC, Garden City, GA (US)

(72) Inventor: William Donald Cook, Savannah, GA (US)

(21) Appl. No.: 18/381,133

(22) Filed: Oct. 17, 2023

Related U.S. Application Data
(60) Provisional application No. 63/416,928, filed on Oct. 17, 2022.

(51) Int. Cl. A47B 88/994; A47B 88/981; B60R 7/08

(52) U.S. Cl. CPC A47B 88/994; A47B 88/981; B60R 7/08

(57) ABSTRACT

A magnetic dinnerware or flatware storage system includes a ferromagnetic lower portion, such as a drawer bottom or counter top surface, and storage elements having magnetic bases that can be placed as desired on the ferromagnetic base to create a customized configuration of the storage system that fits the specific dinnerware to be stored. The storage elements can be posts, storage racks, and the like.

### RELATED APPLICATIONS

This application claims priority to U.S. Provisional Application No. 63/416,928, entitled “MAGNETIC DINNERWARE STORAGE SYSTEM,” filed on Oct. 17, 2022, the entire contents of which are hereby incorporated by reference.

### FIELD OF THE DISCLOSURE

This disclosure is generally directed to a system for storage of plates and other dinnerware, including magnetic elements for holding storage elements in place in a drawer.

### BACKGROUND OF RELATED ART

In passenger transit vehicles, such as airplanes, ships, trains, and automobiles, food service items are often provided for passengers and crew, including serving dishes, flatware, and stemware, for example. In most instances, these service items must be secured within the vessel when not in use for the safety of crew and passengers and to prevent breakage of the service items, yet must be accessible to crew members and passengers for use during transit. Accordingly, well-designed storage solutions for each type of service item are desired.

Fine crystal, china, and flatware (CCF) are required for fine food service in passenger transit. China comes in many different sizes and shapes requiring storage configured to specific pieces. Reconfiguration of the storage area is often needed to accommodate changes in CCF sizes and mix. Storage systems exist that allow reconfiguration of retaining posts to a grid, but this method is inexact and allows for some movement resulting in noise and risk of damage. The grid system also limits the number of posts that can be placed, limiting the weight that the CCF system can accommodate.

### BRIEF DESCRIPTION OF THE DRAWINGS

FIG. 1 is a top perspective view of an example dinnerware storage system.

FIG. 2 is an enlarged view of two example magnetic posts that may find use in the system of FIG. 1.

FIG. 3 is a bottom view of a portion of a cutlery holder that may find use in the system of FIG. 1.

FIG. 4 is a diagrammatic view of an example post and drawer bottom that may find use in the system of FIG. 1, shown in partial cross-section.

FIGS. 5-7 are views of an example magnetic post that may find use with the system of FIG. 1.

FIGS. 8-9 are views of an example slotted magnetic post that may find use in the system of FIG. 1.

FIGS. 10-11 are views of an example slotted magnetic post that may find use in the system of FIG. 1.

FIG. 12 is a diagrammatic view of a slotted post according to FIGS. 8-9 or FIGS. 10-11 in use with example connector panels that may be retained by such a magnetic slotted post, which collectively may find use in the system of FIG. 1.

FIG. 13 includes various views of an example magnetic post that may find use in the system of FIG. 1.

### DETAILED DESCRIPTION

A magnetic dinnerware storage system may improve upon known systems by enabling exact placement of retaining posts, cutlery holders, and other storage elements, minimizing movement, noise and the risk of damage to dinnerware. As disclosed herein, the system may include a ferromagnetic lower portion, such as a drawer bottom, and storage elements having magnetic bases that can be placed as desired on the ferromagnetic base to create a customized configuration of the storage system that fits the specific dinnerware to be stored. In some embodiments, other storage elements can include items such as glassware and cup holders, bottle holders, and can holders. These storage elements may be available today in drawers without a magnetic containment system but are designed for specific size items. Storage elements of this style for the magnetic containment system can be designed in two parts. For example, a glassware and cupholder can be made of two pieces, each magnetically coupled to the base. In some embodiments, the storage elements can be adjusted closer together or further apart to accommodate different sized items.

In some embodiments, retaining posts feature a magnetic base with a retaining shaft of various lengths. A thin sheet of steel or similar ferromagnetic material is placed in the bottom of the storage drawer. The steel sheet may be painted or coated to match the interior color and texture of the drawer. In some embodiments, a veneer (e.g., wood veneer) or other layer that matches the interior texture and color of the drawer may be placed over the ferromagnetic sheet, such that the sheet is not visible to the user. Posts constructed with a magnetic base and a vertical shaft are placed onto the ferromagnetic drawer bottom in the exact position needed to retain the CCF item. This allows for exact placement and a tight fit. Multiple posts can be placed in close proximity as required to support heavier items.

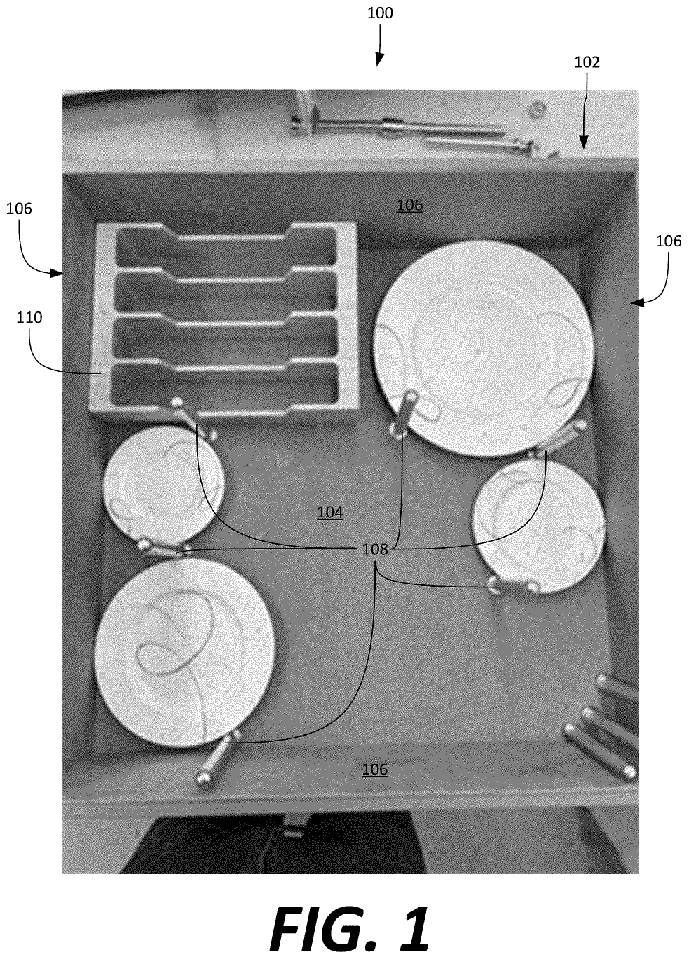

Referring to the figures, wherein like numerals refer to the same or similar features in the various views, FIG. 1 is a top perspective view of an example system 100 for dinnerware storage. The system 100 may include a drawer 102 having a bottom 104 and a plurality of sides 106 at the lateral sides of the bottom 104 and, with the bottom 104, collectively defining an interior. The system 100 further includes one or more posts 108, one or more cutlery racks 110, and/or additional storage elements.

In use, the posts 108, cutlery rack 110, and/or additional storage elements may be magnetically coupled to the drawer bottom 104 in precisely the location desired to secure CCF items within the interior of the drawer 102. For example, a particular plate size may be placed in a desired location in the drawer 102, and then one, two, or more posts 108 may be placed in the drawer 102, touching the plate's edge, and magnetically coupled to the drawer bottom 104 to secure the plate (and any plates stacked on top of it) in place. A similar approach may be taken for china, bowls, and other dinnerware.

The drawer bottom 104 may be or may include a sheet of ferromagnetic material, such as iron, cobalt, nickel, an alloy thereof, a sheet containing portions of one of these elements, etc. The ferromagnetic sheet may cover substantially the entire area of the drawer bottom 104, in embodiments.

Although the instant disclosure makes reference to the storage system being used in a drawer with the drawer bottom being magnetic, it should be understood that any other storage surface may find use with the instant disclosure. For example, a countertop surface, such as a galley counter or bar top, may also be an environment or context for a storage system according to this disclosure.

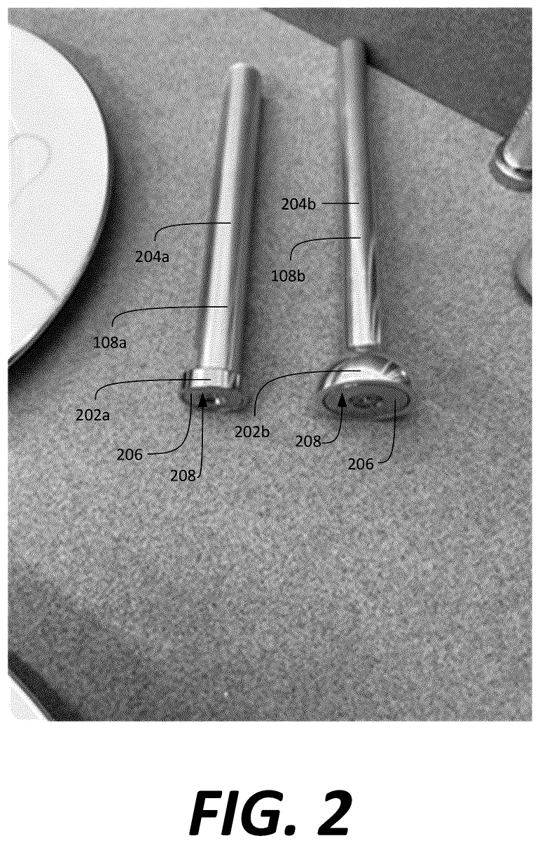

FIG. 2 illustrates two example posts 108a, 108b. Each post 108a, 108b may be or may include a base portion 202a, 202b and a containment body 204a, 204b. The base portion 202a, 202b may include a magnet 206 in a bottom portion of the base portion 202a, 202b. The containment body 204a, 204b may be coupled to the top of the base portion 202a, 202b, in embodiments. The containment body 204a, 204b may be generally cylindrical or frusto-conical. The containment body 204a, 204b may extend upward from the base portion 202a, 202b to the height of a quantity of plates or other dinnerware desired to be secured by the post 108a, 108b. The containment body 204a, 204b may be made from metal, wood, plastic, or another suitable material. The exterior of the containment body 204a, 204b may be covered by a sleeve or other form of a scratch-resistant material, such as fabric, rubber tubing, or plastic tubing, to protect dinnerware secured by the post 108a, 108b against vibration-based and other movement-based damage, and to reduce noise resulting from movement of the plates relative to the post 108a, 108b (e.g., when an airplane, ship, etc. rolls or pitches).

The base portion of the post may have a cylindrical shape (e.g., base portion 202a), a hemispherical shape (e.g., base portion 202b), or another appropriate shape. The base portion 202a, 202b may define a cavity 208 in its lower surface. A magnet 206 may be disposed in the cavity. The magnet 206 may include a countersunk central through-bore, and a screw or other fastener may be threaded through the through-bore to couple the magnet to the base portion 202a, 202b. The base portion 202a, 202b and/or containment body 204a, 204b may also include a countersunk bore into which the screw may be threaded. The base portion 202a, 202b may further include one or more sidewalls surrounding the cavity 208, such that the magnet 206 is not exposed on the sides of the base portion 202a, 202b. The magnet 206 may be disposed in the cavity 208 so as to be flush with a bottom surface of the base portion 202a, 202b (e.g., so that the magnet 206 does not protrude from the base portion 202a, 202b). As a result, when the post 108a, 108b is coupled to the ferromagnetic drawer bottom 102, the magnet 206 is concealed from view.

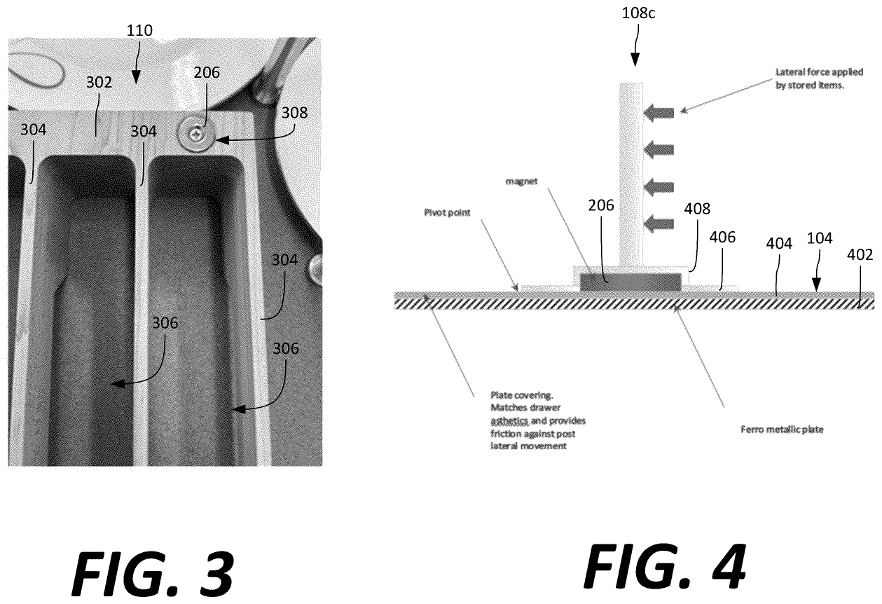

FIG. 3 is a lower view of the cutlery holder 110, which may include a body 302 having a plurality of vertical sidewalls 304 surrounding a plurality of cutlery cavities 306, each configured in size and shape to hold one or more types of cutlery. The body 302 may define one or more lower cavities 308, and a magnet 206 may be disposed in each lower cavity 308. The magnet 206 may be disposed in the cavity 308 so as to be flush with the lower surface of the cutlery holder 110. Lower cavities 308 and magnets 206 may be provided proximate each corner of the cutlery holder 110, in some embodiments. For example, four lower cavities 308 and four magnets 206 may be provided in the rectangular cutlery holder 110.

FIG. 4 is a diagrammatic view of an example post 108c with the drawer bottom 104 of FIG. 1. The ferromagnetic sheet 402 drawer bottom 104 may be covered, on its upper surface, by a fabric, veneer, or other non-scratch layer 404. The fabric or other layer 404 may provide protection for the bottom of dinnerware stored in the drawer 102, and may also provide friction for additional resistance to lateral movement (e.g., in addition to the magnetic force between the post and the ferromagnetic sheet). Further, the layer 404 may provide material consistency with the environment in which the sheet 402 is used. For example, where the sheet is used in a bar top, galley surface, drawer, etc. the layer 404 may be a veneer that matches the surrounding materials and appearance of the surface, such that the sheet 402 is functional but concealed.

The base portion 202c of the post 108c may include a lower disk portion 406 and an upper disk portion 408, in embodiments. Each disk portion 406, 408 may be cylindrical. The lower disk portion 406 may have a diameter that is substantially wider than the upper disk portion 408, and substantially wider than the magnet 206, in embodiments. The lower disk portion 406 may have a lower surface, which has the diameter of the lower disk portion 406, that provides a pivot point relative to the drawer bottom 104 that is significantly laterally offset from the post containment body 204c, resulting in a high amount of force required to tip or tilt the post containment body 204c, and thereby providing a secure, stable containment for dinnerware when the post 108c is coupled to a drawer bottom 104. Such a base shape may find particular use in transportation applications, in which drawers may be tipped when in use, and in which the vehicle itself may pitch and roll, resulting in significant lateral force being applied by gravity and momentum to dinnerware stored in the drawer 102, and thus to the posts.

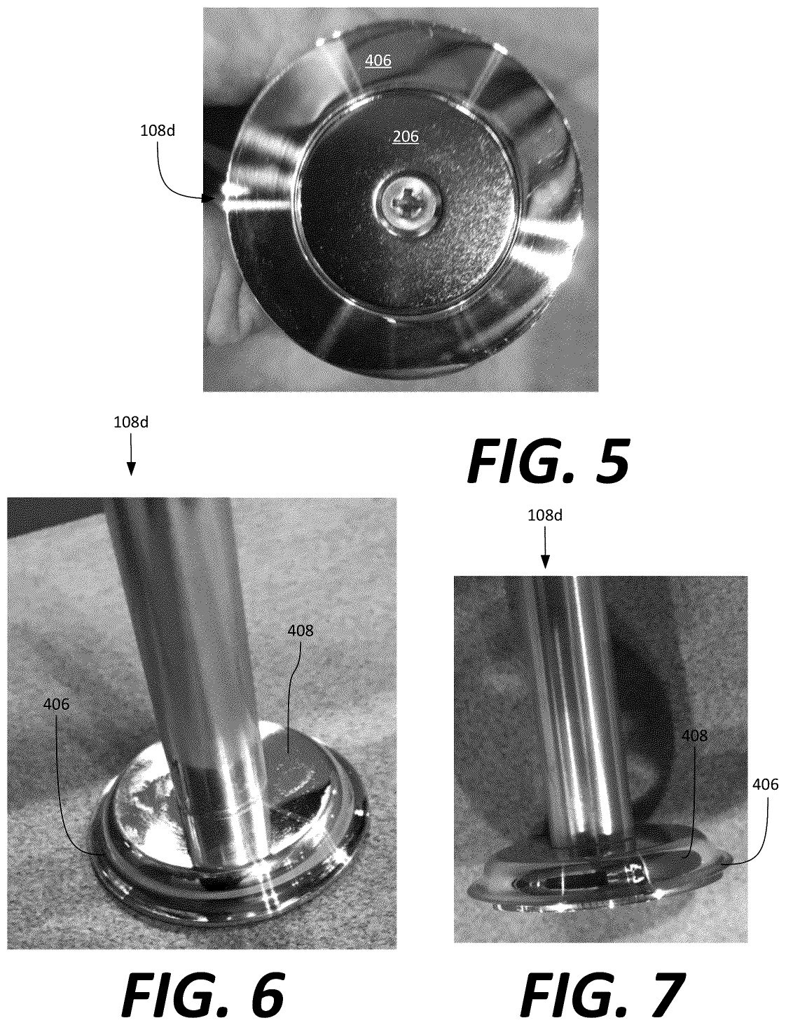

FIGS. 5-7 illustrate an example post 108d having a base 202d that includes an upper disk portion 408 and a lower disk portion 406. The magnet 206 may be flush with the lower surface of the lower disk portion 406. The post 108d of FIGS. 5-7 may define a wide tipping point, as discussed above.

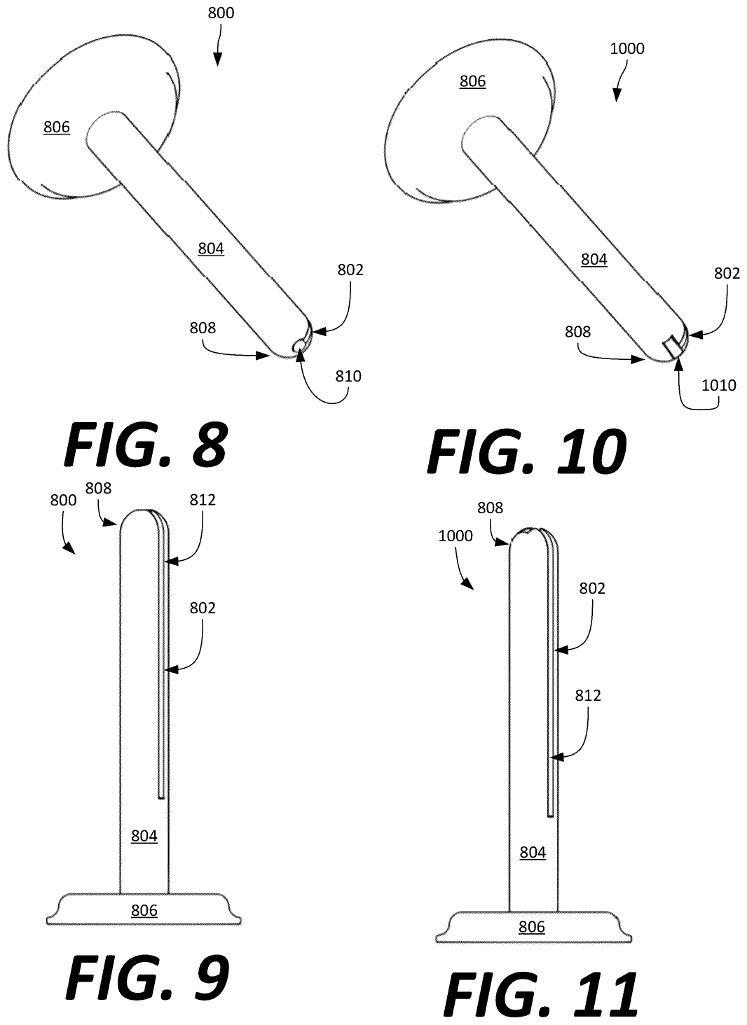

FIGS. 8-9 are views of an example slotted magnetic post 800 that may find use in the system of FIG. 1. The post 800 includes a longitudinal slot 802 (i.e., extending parallel to a longitudinal axis of a body 804 of the post 800, where the axis extends through the base portion 806 and through a top 808 of the body 804 that is opposite the base portion 806). The longitudinal slot may include a center portion 810 and a radial portion 812. The center portion 810 may be a generally circular bore partially into the body 804. The center portion 810 may be at the radial center of the body 804, and thus may be disposed about the axis. The radial portion may be defined by a gap of generally uniform width extending radially from the center portion 810 to a radial edge of the body 804. The radial portion 812 may be defined by two sidewalls that extend longitudinally parallel to the axis and radially perpendicular to the axis. The sidewalls may be generally parallel to each other, in some embodiments.

FIGS. 10-11 are views of an example slotted magnetic post 1000 that may find use in the system of FIG. 1. The post 1000 may be substantially identical to the post 800, except the post 1000 may have a center portion 1010 that is generally rectangular.

For both the post 800 and the post 1000, the center portion 810, 1010 may have a width that is larger than a width of the radial portion 812. As a result, as described below, a storage body, such as a divider panel, may be coupled to the post 800, 1000 so that the storage body is securely retained by the post 800, 1000.

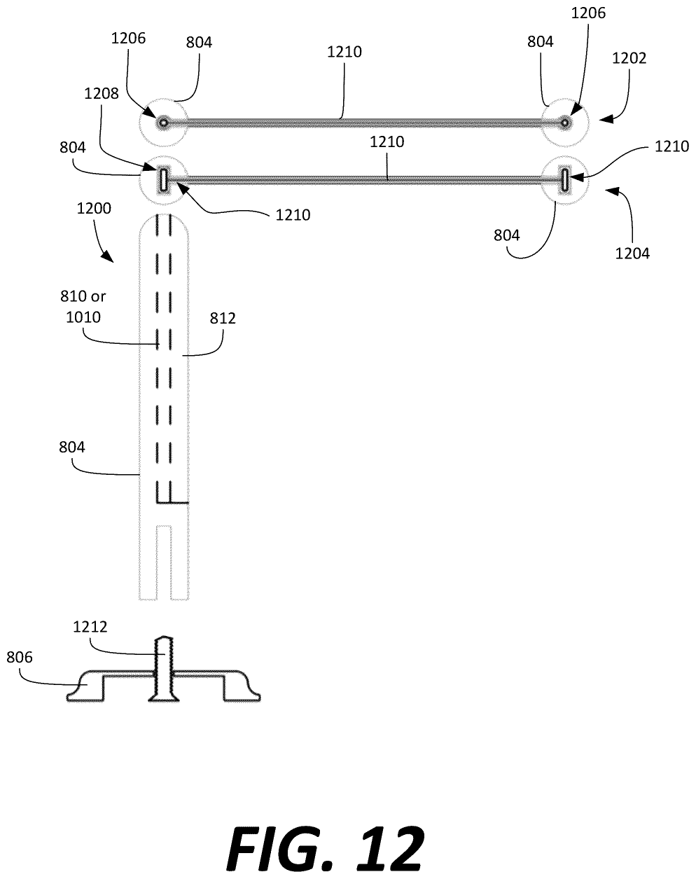

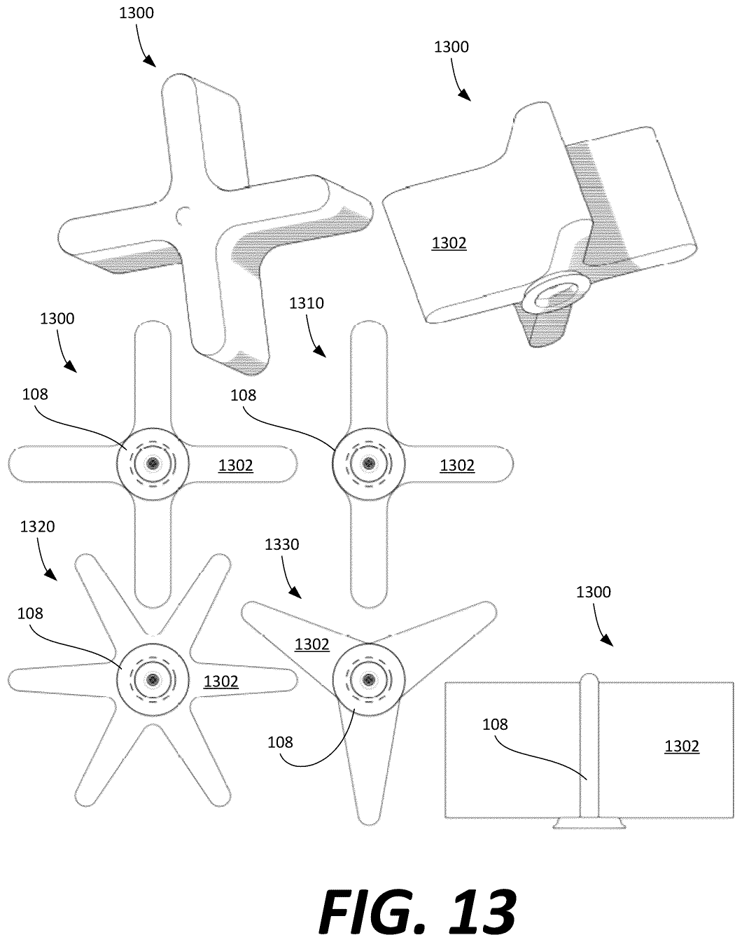

FIG. 12 is a diagrammatic view of a slotted post 1200, which may be either post 800 or post 1000, along with example connector panels 1202, 1204 that may be retained by the post 1200. The connector panels 1202, 1204 are shown from above to illustrate the thickness and radial dimensions of the connector panels 1202, 1204 relative to the post 1200, while the post 1200 is shown in cross-section from the side. The connector panels 1202, 1204 can be flexible, according to some embodiments. The connector panels 1202, 1204 can be rigid, according to some embodiments. One of the connector panels 1202, 1204 can be rigid and the other of the connector panels 1202, 1204 can be flexible, according to some embodiments. Each connector panel 1202, 1204 may have an edge portion 1206, 1208 that has a shape that corresponds to a center portion 810 or 1010 of the post 1200 and to the radial portion 812 of the post 1200.

Connector panel 1202 has an edge portion 1206 that has a circular end that is configured to mate with the circular center portion 810 and a radial portion that extends radially from the circular end and is configured to slot into the radial portion 812. Connector panel 1204 has an edge portion 1208 that has a rectangular end that is configured to mate with the rectangular center portion 1010 and a radial portion that extends radially from the rectangular end and is configured to slot into the radial portion 812. Each connector panel 1202, 1204 also includes a panel portion 1210 that extends from one edge portion 1206, 1208 to another edge portion 1206, 1208. Accordingly, the connector panel 1202, 1204 may be coupled to the two posts 1200 to be placed as a divider in a desired position. The connector panels 1202, 1204 and post 1200 may be used in the system 100 of FIG. 1, in embodiments.

Although the post 1200 is illustrated without a magnet, the post 1200 may include a magnet secured to the body 804 with a screw 1212 as described with respect to other embodiments herein.

FIG. 13 includes various views of various winged magnetic posts 1300, 1310, 1320, 1330. Each winged post 1300, 1310, 1320, 1330 may include the same post structure as one of the posts 108, with an additional outer shape or layer that includes one or more wings 1302 extending radially outward from the post body. The outer shape or layer can be, for example, foam or the like. The post 1300 includes four wings 1302, the post 1310 includes three wings 1302, the post 1320 includes six wings 1302, and the post 1330 includes three wings 1302. The wings 1302 may have substantially the same height as the post body, in some embodiments, or just less than the height of the post body. The multiple wings 1302 may be uniformly circumferentially distributed, as in posts 1300, 1320, 1330, or may be irregularly circumferentially distributed, as in post 1310.

In some embodiments, a storage system for use with flatware or dinnerware includes a storage surface including a ferromagnetic sheet and a scratch-resistant layer disposed over the sheet. In some embodiments, the storage system includes a plurality of posts. In some embodiments, the plurality of posts include a base portion and a magnet disposed in the base portion. In some embodiments, the magnet is configured to interact with the ferromagnetic sheet to selectively couple a respective post with the storage surface.

In some embodiments, the storage surface is one of a drawer bottom or a counter surface.

In some embodiments, the scratch-resistant layer is one or more of a fabric or a wood veneer.

In some embodiments, each post includes an outer sleeve comprising plastic, rubber, or fabric.

In some embodiments, for each post, a lower surface of the magnet is flush with a bottom surface of the base portion.

In some embodiments, the storage system includes a storage rack. In some embodiments, the storage rack includes a body defining one or more slots and one or more second magnets disposed in a bottom portion of the body. In some embodiments, the one or more second magnets are configured to interact with the ferromagnetic sheet to selectively couple the storage rack with the storage surface.

In some embodiments, a storage system for use in a vehicle includes a ferromagnetic sheet configured to be disposed in or on a storage surface. In some embodiments, the storage system includes a plurality of posts. In some embodiments, each post includes a base portion; and a first magnet disposed in the base portion. In some embodiments, the first magnet is configured to interact with the ferromagnetic sheet to selectively couple a respective post with the storage surface. In some embodiments, the storage system includes a storage rack that includes a body defining one or more slots; and one or more second magnets disposed in a bottom portion of the body. In some embodiments, the one or more second magnets are configured to interact with the ferromagnetic sheet to selectively couple the storage rack with the storage surface.

In some embodiments, each post further includes a generally cylindrical body extending from the base portion. In some embodiments, the base portion has a larger diameter than the body.

In some embodiments, the base portion of each post has a cylindrical shape or a hemispherical shape.

In some embodiments, each post includes an outer sleeve comprising plastic, rubber, or fabric.

In some embodiments, for each post, a lower surface of the first magnet is flush with a bottom surface of the base portion.

In some embodiments, the storage system includes the storage surface. In some embodiments, the storage surface includes a layer disposed over the ferromagnetic sheet so as to conceal the ferromagnetic sheet.

In some embodiments, a post for use in a storage system for flatware or dinnerware in a vehicle includes a generally cylindrical body comprising plastic, metal, or wood. In some embodiments, the post includes a base portion disposed at an end of the body. In some embodiments, the base portion includes one or more of: a hemispherical shape; or a cylindrical shape. In some embodiments, the post includes a magnet disposed in the base portion.

In some embodiments, the base portion includes a first disk portion having a first diameter; a second disk portion, under the first disk portion, having a second diameter. In some embodiments, the second diameter is larger than the first diameter.

In some embodiments, the magnet is flush with a bottom surface of the second disk portion.

In some embodiments, the magnet is disposed in both the first disk portion and the second disk portion.

In some embodiments, the magnet defines a through-bore. In some embodiments, the post further includes a fastener disposed in the through-bore to couple the magnet to the body.

In some embodiments, a length of the post body is greater than a diameter of the post body.

In some embodiments, the post includes a longitudinal slot for retaining a storage divider.

In some embodiments, the post includes a plurality of wings extending radially outward from the body.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

What is claimed is:

1. A storage system for use with flatware or dinnerware, the storage system comprising:
a storage surface comprising a ferromagnetic sheet and a scratch-resistant layer disposed over the sheet; and
a plurality of posts, each post comprising:
a base portion; and
a magnet disposed in the base portion, wherein the magnet is configured to interact with the ferromagnetic sheet to selectively couple a respective post with the storage surface.

2. The storage system of claim 1, wherein the storage surface is one of a drawer bottom or a counter surface.

3. The storage system of claim 1, wherein the scratch-resistant layer is one or more of a fabric or a wood veneer.

4. The storage system of claim 1, wherein each post comprises an outer sleeve comprising plastic, rubber, or fabric.

5. The storage system of claim 1, wherein, for each post, a lower surface of the magnet is flush with a bottom surface of the base portion.

6. The storage system of claim 1, further comprising:
a storage rack, the storage rack comprising:
a body defining one or more slots; and
one or more second magnets disposed in a bottom portion of the body, wherein the one or more second magnets are configured to interact with the ferromagnetic sheet to selectively couple the storage rack with the storage surface.

7. A storage system for use in a vehicle, the storage system comprising:
a ferromagnetic sheet configured to be disposed in or on a storage surface;
a plurality of posts, each post comprising:
a base portion; and
a first magnet disposed in the base portion, wherein the first magnet is configured to interact with the ferromagnetic sheet to selectively couple a respective post with the storage surface; and
a storage rack, the storage rack comprising:
a body defining one or more slots; and
one or more second magnets disposed in a bottom portion of the body, wherein the one or more second magnets are configured to interact with the ferromagnetic sheet to selectively couple the storage rack with the storage surface.

8. The storage system of claim 7, wherein each post further comprises a generally cylindrical body extending from the base portion, wherein the base portion has a larger diameter than the body.

9. The storage system of claim 7, wherein the base portion of each post has a cylindrical shape or a hemispherical shape.

10. The storage system of claim 7, wherein each post comprises an outer sleeve comprising plastic, rubber, or fabric.

11. The storage system of claim 7, wherein, for each post, a lower surface of the first magnet is flush with a bottom surface of the base portion.

12. The storage system of claim 7, further comprising the storage surface, wherein the storage surface comprises a layer disposed over the ferromagnetic sheet so as to conceal the ferromagnetic sheet.

13. A post for use in a storage system for flatware or dinnerware in a vehicle, the post comprising:
a generally cylindrical body comprising plastic, metal, or wood;
a base portion disposed at an end of the body, wherein the base portion comprises one or more of:
a hemispherical shape; or
a cylindrical shape; and
a magnet disposed in the base portion.

14. The post of claim 13, wherein the base portion comprises:
a first disk portion having a first diameter; and
a second disk portion, under the first disk portion, having a second diameter;
wherein the second diameter is larger than the first diameter.

15. The post of claim 14, wherein the magnet is flush with a bottom surface of the second disk portion.

16. The post of claim 14, wherein the magnet is disposed in both the first disk portion and the second disk portion.

17. The post of claim 14, wherein the magnet defines a through-bore, wherein the post further comprises a fastener disposed in the through-bore to couple the magnet to the body.

18. The post of claim 14, wherein a length of the post body is greater than a diameter of the post body.

19. The post of claim 14, wherein the post comprises a longitudinal slot for retaining a storage divider.

20. The post of claim 14, further comprising a plurality of wings extending radially outward from the body.
